(19) United States
(12) Patent Application Publication
(10) Pub. No.: US 2009/0290877 A1
(43) Pub. Date: Nov. 26, 2009

(54) Monitoring for High Speed OFDM Signal Transmission

(75) Inventors: Jianjun Yu, Princeton, NJ (US); Ting Wang, West Windsor, NJ (US); Junqiang Hu, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/124,402

(22) Filed: May 21, 2008

(51) Int. Cl. H04J 14/02

(52) U.S. Cl. 398/79

(57) ABSTRACT

A method includes coupling an optical signal upconverted to a higher frequency and a digital signal having a bit rate similar to that of a subchannel of the upconverted optical signal, and obtaining, responsive to the coupling, a transmission signal with an optical carrier frequency carrying the digital signal and subchannels about the optical carrier frequency carrying the upconverted optical signal, the bit rate of the optical carrier being similar to that of the subchannels. In a preferred embodiment, the coupling includes electrically power coupling the upconverted optical signal with the digital signal, and modulating the coupled optical carrier frequency carrying the digital signal and subchannels about the optical carrier frequency carrying the upconverted optical signal.

### BACKGROUND OF THE INVENTION

The present invention relates generally to optical communications and, more particularly, to monitoring for high-speed OFDM signal transmission.

Orthogonal frequency division multiplexing (OFDM) is an attractive modulation format in the future optical communication system. This technology can simultaneously transmit multiply sub-channel signals in a limited bandwidth. Therefore, OFDM is a high-spectrum efficiency technique. For a regular digital signal, such as on/off shift key (OOK) modulation signal, we can easily monitor the eye diagram and BER. However, for OFDM optical signal, this signal in the transmission fiber is an analog signal, it will be difficult to monitor without demodulation and a serial A/D conversion, FFT conversion, and other processions. Although optical signal to noise ratio is one way to monitor the OFDM signals, but it cannot show the detail information, for example when the OFDM signals are suffered from strong nonlinear, dispersion or polarization mode dispersion effects.

Accordingly, there is a need for a simple way to monitor the OFDM optical signal in the fiber.

### SUMMARY OF THE INVENTION

In accordance with the invention, a method includes coupling an optical signal upconverted to a higher frequency and a digital signal having a bit rate similar to that of a subchannel of the upconverted optical signal, and obtaining, responsive to the coupling, a transmission signal with an optical carrier frequency carrying the digital signal and subchannels about the optical carrier frequency carrying the upconverted optical signal, the bit rate of the optical carrier being similar to that of the subchannels. In a preferred embodiment, the coupling the step includes electrically power coupling the upconverted optical signal with the digital signal, and modulating the coupled optical carrier frequency carrying the digital signal and subchannels about the optical carrier frequency carrying the upconverted optical signal.

In accordance another aspect of the invention, an apparatus includes a coupler for combining an OFDM optical signal upconverted to a higher frequency and a digital signal having a bit rate similar to that of a subchannel of the upconverted optical signal; and a modulator for generating a transmission signal with an optical carrier frequency carrying the digital signal and subchannels about the optical carrier frequency carrying the upconverted optical signal, the bit rate of the optical carrier being similar to that of the subchannels.

### BRIEF DESCRIPTION OF DRAWINGS

These and other advantages of the invention will be apparent to those of ordinary skill in the art by reference to the following detailed description and the accompanying drawings, where like elements are like numbered when appearing in more than one drawing figure.

FIGS. 1A, 1B and 1C are block diagrams of exemplary optical systems for monitoring high speed OFDM signal transmission in accordance with the invention.

### DETAILED DESCRIPTION

The application is directed to a method that uses a separated low speed signal to monitor the OFDM optical signals without touching the OFDM optical signals.

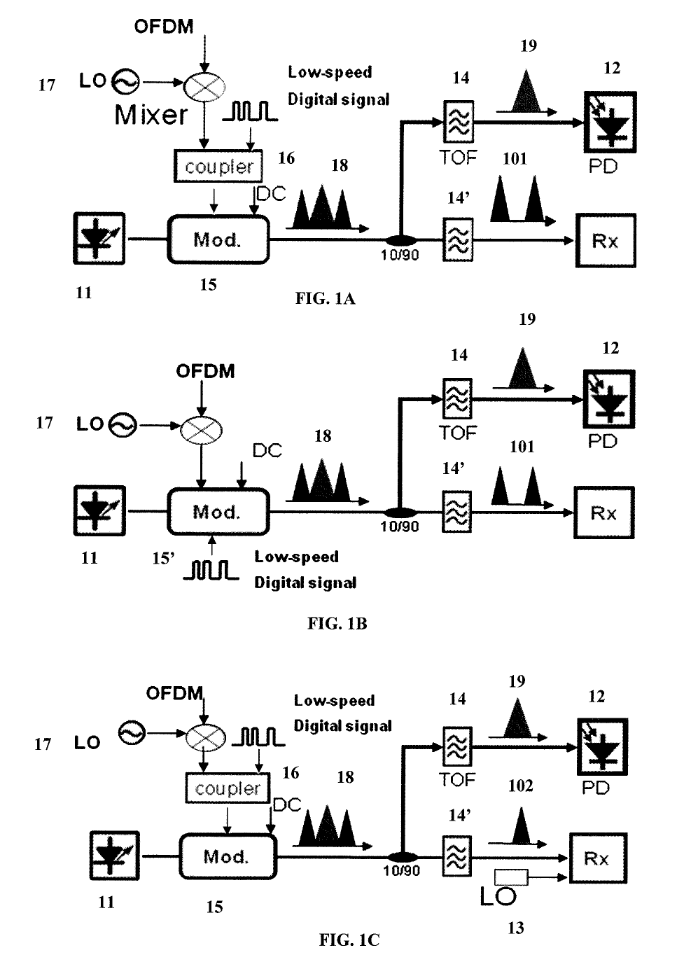

Referring to the block diagrams, FIG. 1A, FIG. 1B and FIG. 1C, there are shown exemplary alternative optical network configurations for monitoring analog OFDM optical signals in accordance with the invention. An OFDM signal is up converted to a local oscillator LO 17 frequency which is then coupled 16 via an electrical power coupler with a digital signal. The up converted OFDM and digital signal are modulated 15 by a DC biased external modulator tied to an optical switch 11 to produce sideband channels of the digital signal about the up converted OFDM signal 18. The modulated signal 18 is passed through a 10/90 ratio 1 to 2 port. One leg of the optical port is tied to an upper optical filter 14 terminating to a photodiode PD 12 and the other leg of the port is tied to an optical filter 14′ that leads to a receiver Rx.

In the embodiment of FIG. 1A, one single-arm intensity modulator 15 is employed. The OFDM electrical is up-converted by an electrical mixer. If the repetitive frequency of the local oscillator LO 17 is f₀, the OFDM electrical signals will be carried on the f₀ frequency. The OFDM signals will be carried by a few sub-channels 18. As an example, if the OFDM electrical signals are 10 Gbit/s and it is carried by 100 sub-channels, then the bit rate of each sub-channel is around 100 Mbit/s.

The present invention combines another low-speed digital binary phase shift keyed BPSK signal with a bit rate similar to that of the sub-channel in OFDM electrical signals by using an electrical power coupler 16. In order to reduce the electrical interference between the up-converted OFDM signal and the low-speed electrical digital signal, the embodiment of FIG. 1B can be employed.

In the embodiment of FIG. 1B, the intensity modulator 15′ has dual-arms. The up-converted OFDM signal and low-speed digital signal are each driven by a different modulator port. In both the FIG. 1A and FIG. 1B embodiments, the DC bias on the external modulator 15, 15′ should be adjusted to make sure an optical spectrum can be generated as shown by the output signal 18, where the two sidebands carry the up-converted OFDM signal, while the optical carrier mainly carries the low-speed digital signal. In order to meet this requirement, the DC bias of the external modulator should be close to a null point or V_{π}. It means that the optical output power from the external modulator is close to being minimal when no RF signals exist. If the RF power to drive the external modulator is not strong enough, an electrical power amplifier will be needed for both the electrical OFDM and low-speed digital signal.

In both the FIG. 1A and FIG. 1B embodiments, we can use a tap coupler 10/90 such as 10% power tapped, the optical carrier is separated by the upper optical filter 14. Then we use a low-speed photo-diode PD 12 to detect the separated optical carrier to monitor this signal. Since the bit rate of this optical carrier is similar to that of the sub-channel of the OFDM optical signals, therefore, we only need to check this low-speed digital signal before we can know the performance of the OFDM signals and monitor the OFDM signals.

In the receiver, we use another optical filter 14′ to remove the optical carrier. The two sidebands 101 will beat when the OFDM optical signals are detected by a receiver (Rx). Therefore, we do not need a complex coherent detection for this OFDM optical signal detection. However, due to two peaks, it will suffer from fiber dispersion. For 10 Gbit/s signal transmission over ultra-long distance, such as 4000 km SMF-28 transmission at a carrier of 8 GHz (LO frequency), this scheme will need dispersion compensation.

In order to overcome the fiber dispersion problem in FIG. 1A and 1B, an alternative embodiment in FIG. 1C is proposed. On the transmitter side, the same configuration as those in FIG. 1A and 1B are employed. On the receiver side, we use an optical filter to get only one sideband 102. Therefore, a coherent detection (heterodyne) receiver is required. It means we need a LO optical signal 13, a 90 degree hybrid or a polarization-diversity receiver. Therefore, the receiver side is more complex than that of FIG. 1A or 1B, but with the embodiment of FIG. 1C dispersion compensation is not needed.

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations which, not explicitly shown or described herein, embody the principles of the invention and are within their spirit and scope.

What is claimed is:

1. A method comprising the step of:
coupling an optical signal upconverted to a higher frequency and a digital signal having a bit rate similar to that of a subchannel of the upconverted optical signal; and
obtaining, responsive to the coupling step, a transmission signal with an optical carrier frequency carrying the digital signal and subchannels about the optical carrier frequency carrying the upconverted optical signal, the bit rate of the optical carrier being similar to that of the subchannels.

2. The method of claim 2, wherein the optical signal comprises an orthogonal frequency division multiplexed OFDM optical signal.

3. The method of claim 1, wherein the coupling the step comprises electrically power coupling the upconverted optical signal with the digital signal.

4. The method of claim 1, wherein the coupling the step comprises driving a modulator with dual ports with the optical signal at one port and the digital signal at the other port.

5. The method of claim 1, wherein the obtaining step comprises modulating the coupled optical carrier frequency carrying the digital signal and subchannels about the optical carrier frequency carrying the upconverted optical signal.

6. The method of claim 5, wherein a DC bias of the modulating is appropriate for generating an optical spectrum where the optical carrier frequency carries the digital signal and subchannels about the optical carrier frequency carry the upconverted optical signal.

7. The method of claim 1, further comprising the step of monitoring the optical carrier frequency carrying the digital signal separated from the transmission signal, the bit rate of the optical carrier being similar to that of the subchannels enabling a monitoring of the separated optical carrier indicative of the optical signal carried by the subchannels.

8. The method of claim 1, wherein the step of monitoring comprises optically filtering out the optical carrier frequency carrying the digital signal.

9. An apparatus comprising:
a coupler for combining an OFDM optical signal upconverted to a higher frequency and a digital signal having a bit rate similar to that of a subchannel of the upconverted optical signal; and
a modulator for generating a transmission signal with an optical carrier frequency carrying the digital signal and subchannels about the optical carrier frequency carrying the upconverted optical signal, the bit rate of the optical carrier being similar to that of the subchannels.

10. The method of claim 9, wherein the coupler comprises an electrical power coupler.

11. The method of claim 9, wherein the modulator comprises a modulator with dual ports with the OFDM optical signal at one port and the digital signal at the other port.

12. The method of claim 9, wherein a DC bias of the modulator is appropriate for generating an optical spectrum where the optical carrier frequency carries the digital signal and subchannels about the optical carrier frequency carry the upconverted optical signal.
